(19) United States
(12) Patent Application Publication
(10) Pub. No.: US 2026/0139783 A1
(43) Pub. Date: May 21, 2026

(54) VALVE CONNECTION ADAPTER AND VALVE UNIT

(71) Applicant: BUERKERT WERKE GmbH & Co. KG, Ingelfingen (DE)

(72) Inventor: Steffen BREUNINGER, Ingelfingen (DE)

(21) Appl. No.: 19/393,011

(22) Filed: Nov. 18, 2025

(30) Foreign Application Priority Data
Nov. 19, 2024 (DE) 202024106679.0

(51) Int. Cl. F16L 47/16

(52) U.S. Cl. CPC F16L 47/16

(57) ABSTRACT

A valve connection adapter for connecting a fluidic connecting pipe to a valve has an adapter sleeve which includes a valve-side axial end and an opposite, pipe-side axial end and an axial passage opening, wherein the passage opening has an internal thread at a pipe-side end region and a widening at the valve-side end region. Furthermore, a valve unit is presented.

### TECHNICAL FIELD

The disclosure relates to a valve connection adapter for connecting a fluidic connecting pipe to a valve. Furthermore, the disclosure relates to a valve unit having such a valve connection adapter.

### BACKGROUND

Such valve connection adapters and valve units having a valve connection adapter are known.

Valve units are part of valves or drives or control devices for valves and have one or more connections by means of which fluidic connecting pipes can be connected to conduct a fluid into or out of the valve, the drive or the control device.

There are two types of connections for this. One type has an internal thread in its passage opening, into which the connecting pipe is screwed by means of a complementarily designed external thread on one axial end of the connecting pipe. In the second type, the connecting pipe is fastened without a thread by means of a clamping sleeve that is arranged in the connection and clamps the connecting pipe more tightly the harder the connecting pipe is pulled out of the connection in the axial direction. These clamping sleeves are also known under the name “collet.”

Since only connecting pipes having an external thread or connecting pipes without an external thread can be connected to each of the connections, valves usually have connections of both the one type and the other type.

The disclosure provides a valve connection adapter for connecting a fluidic connecting pipe to a valve, by means of which both connecting pipes having an external thread and connecting pipes without an external thread can be connected. The disclosure is also to provide a valve unit having such a valve connection adapter.

### SUMMARY

The disclosure provides a valve connection adapter for connecting a fluidic connecting pipe to a valve, including an adapter sleeve which has a valve-side axial end and an opposite, pipe-side axial end and an axial passage opening. Here, the passage opening has an internal thread at a pipe-side end region and a widening, for example a conical widening, at the valve-side end region.

For the purposes of the disclosure, the term “valve” encompasses a valve, a drive of a valve, and a control device of a valve. This means that the valve connection adapter is configured for connecting a fluidic connecting pipe to a valve, to a drive of a valve, and/or to a control device of a valve.

Furthermore, for the purposes of the disclosure, the term “connecting pipe” covers any type of pipe or hose, regardless of whether it is of a rigid, flexible, or elastic design.

It has been found that by means of the valve connection adapter according to the disclosure, for one thing, connecting pipes having an external thread can be connected by screwing the connecting pipe into the pipe-side end region, and, for another thing, connecting pipes without an external thread can be connected by clamping them in the valve-side end region of the adapter sleeve by means of a clamping sleeve. In this way, a fluidic connecting pipe having an external thread can be connected to any connection designed with such an adapter sleeve without using a clamping sleeve, and a fluidic connecting pipe without an external thread can be connected using a clamping sleeve. Each of these connections is therefore designed to be flexible for both connection types. All that is required is to insert a clamping sleeve or to remove or omit it, depending on the connection type.

In one embodiment, the valve-side end region continues into a cylindrical section toward the valve-side end. This configuration has the advantage that the cylindrical section constitutes a seating for a cylindrically configured collar of the clamping sleeve, resulting in the clamping sleeve clamping the connecting pipe particularly effectively when the latter is pulled away from the valve in the axial direction.

In a further embodiment, the adapter sleeve has depressions and/or projections on its outer circumference, by means of which the adapter sleeve can be connected in a form-fitting manner to a housing wall of a valve housing.

Here, the adapter sleeve may have circumferential grooves and/or an anti-rotation locking contour on its outer circumference in order to fasten the adapter sleeve particularly effectively to the housing wall and to secure it against axial withdrawal and/or rotation in the circumferential direction.

Furthermore, it may be provided that the valve connection adapter includes a clamping sleeve which is provided with axial slits and has a valve-side axial end and an opposite, pipe-side axial end and has, at its valve-side end, a collar projecting radially outward in segments defined by the slits. The segments and the collar here are adapted in cross-section to the geometry of the passage opening such that the clamping sleeve can be axially inserted into the passage opening with the segments deflecting inward, and the collar engages in the widening. This design causes the clamping sleeve to be captively retained on the adapter sleeve, even if no connecting pipe is attached. Furthermore, a connecting pipe that is connected by means of the clamping sleeve is reliably fastened in the valve connection adapter, since the connecting pipe is clamped all the more tightly the harder the connecting pipe is pulled out of the adapter sleeve in the axial direction.

According to one aspect, the clamping sleeve here is configured such that it can be pulled out of the adapter sleeve without using a tool when no connecting pipe is fastened in the valve connection adapter.

Moreover, the clamping sleeve may have a circumferentially surrounding flange at its pipe-side end, which protrudes radially in relation to the adapter sleeve and forms an axial stop. In this way, a defined arrangement of the clamping sleeve relative to the adapter sleeve is ensured.

To achieve the above-mentioned object, also provided according to the disclosure is a valve unit including a valve connection adapter according to the disclosure and having the aforementioned advantages and a valve housing having a connection port which is formed in the housing wall of the valve housing and in which the adapter sleeve is inserted and secured therein against rotation and axial withdrawal.

In this context, the adapter sleeve may be pressed or glued into the connection port or overmolded therein in order to effectively fasten it to the housing wall with little effort.

In one embodiment, a connecting pipe is screwed into the thread of the adapter sleeve, whereby it is securely fastened and connected in terms of flow.

In an alternative embodiment, a connecting pipe protrudes into the clamping sleeve and is radially clamped therein, for example wherein the collar presses against the wall of the widening. In this way, the connecting pipe is securely fastened and connected in terms of flow, for example if it has no external thread.

Provision may be made here that the clamping sleeve has barb extensions on its inside which protrude obliquely inward and toward the valve and which axially secure the connecting pipe received. This provides particularly reliable protection against withdrawal of the connecting pipe.

Furthermore, in a valve unit having a valve connection adapter including a clamping sleeve, a sealing ring may be seated on a shoulder in the connection port axially between the shoulder and a face side of the clamping sleeve in order to ensure a tight fluid communication.

According to a further embodiment, the connection port has a stop on which the adapter sleeve rests on its face side. The adapter sleeve is thus arranged in the connection port in a defined manner and the resistance is higher when the adapter sleeve is pushed toward the valve.

### BRIEF DESCRIPTION OF THE DRAWINGS

FIG. 1 shows an exploded view of a valve unit according to the disclosure with a valve connection adapter according to the disclosure;

FIG. 2 shows a sectional view of the valve unit from FIG. 1;

FIG. 3 shows a sectional view of an adapter sleeve of the valve connection adapter from FIG. 1;

FIG. 4 shows a sectional view of a clamping sleeve of the valve connection adapter from FIG. 1;

FIG. 5 shows a detailed view of the valve unit from FIG. 1 in section;

FIG. 6 shows a detailed view of the valve unit from FIG. 1 with a pipe connected by means of the valve connection adapter with a clamping sleeve; and

FIG. 7 shows a detailed view of the valve unit from FIG. 1 with a pipe screwed to the adapter sleeve without the clamping sleeve.

### DETAILED DESCRIPTION

The detailed description below, in conjunction with the accompanying drawings, in which like numerals refer to like elements, is intended as a description of various embodiments of the subject matter disclosed and is not intended to constitute the only embodiments. Each embodiment described in this disclosure is merely used as an example or illustration and should not be construed as preferred or advantageous over other embodiments.

All of the features disclosed below with respect to the exemplary embodiments and/or the accompanying figures may be combined alone or in any desired sub-combination with features of the aspects of the present disclosure, including features of preferred embodiments, provided that the resulting combination of features is useful to a person skilled in the art.

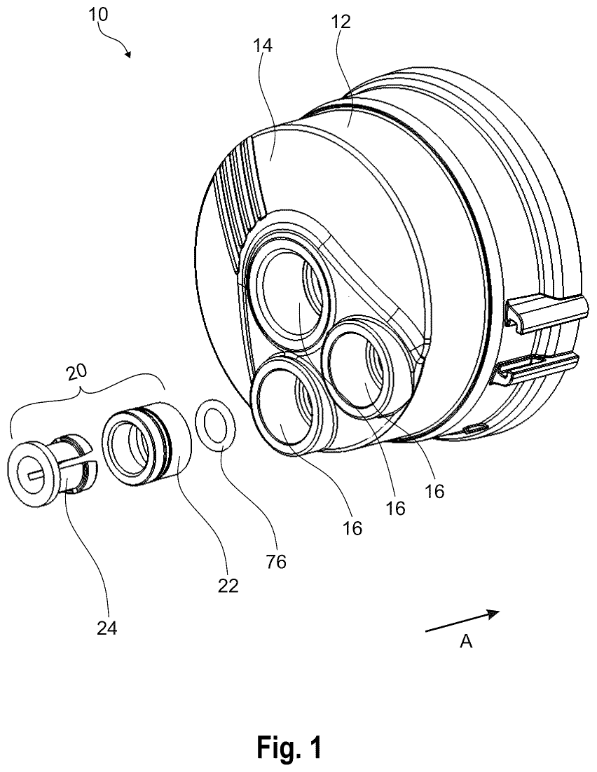

FIG. 1 shows a valve unit 10 having a valve housing 12 and a valve connection adapter 20.

The valve housing 12 is, for example, part of a valve, a valve drive, or a valve control device.

The valve housing 12 has a housing wall 14 in the form of an axial end wall, in which three connection ports 16 are formed, each for a respective fluid line.

Of course, in an alternative embodiment, the valve housing 12 may have any desired number of connection ports 16.

Furthermore, each of the connection ports 16 may include a valve connection adapter 20.

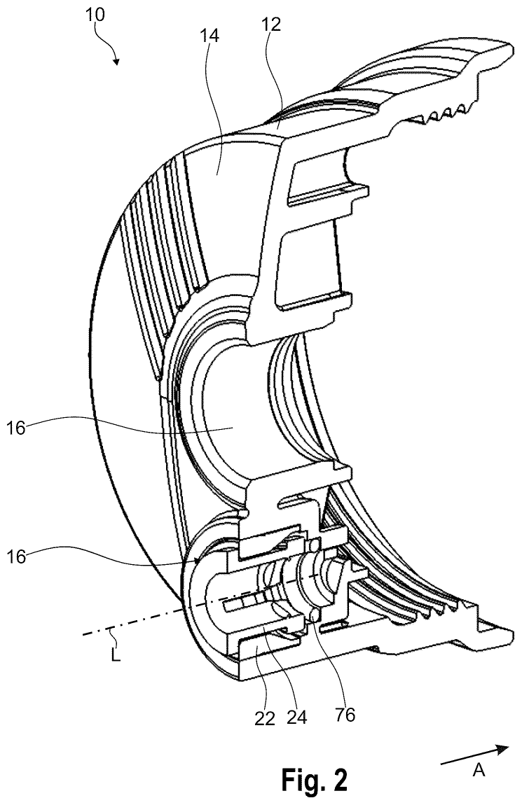

The valve connection adapter 20 comprises an adapter sleeve 22 and an optional clamping sleeve 24, which can be used together with the adapter sleeve 22 (see FIG. 2) to connect, for example, connecting pipes without external threads, as will be discussed later.

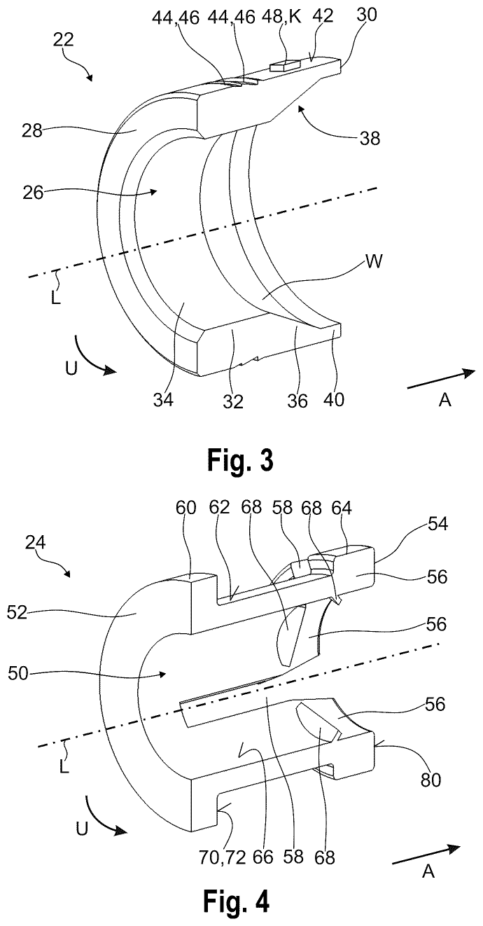

The adapter sleeve 22 (see FIG. 3) has an axial passage opening 26 that extends from a pipe-side axial end 28 in the axial direction A to an opposite, valve-side axial end 30.

Adjacent to the pipe-side axial end 28, the adapter sleeve 22 has a pipe-side end region 32 having an internal thread 34.

Between the pipe-side end region 32 and the valve-side axial end 30, the adapter sleeve 22 has a valve-side end region 36 having a widening 38, which is, for example, of a conical shape.

Basically, the widening 38 may essentially have any desired shape, as long as the radial cross-section or diameter of the valve-side end region 36 increases in the axial direction A, for example continuously.

In the present embodiment, the adapter sleeve 22 has a cylindrical section 40 which is adjacent to the valve-side axial end 30 and into which the valve-side end region 36 continues in the axial direction A.

Alternatively, the cylindrical section 40 may be omitted and the valve-side end region 36 may be adjacent to the valve-side axial end 30.

In a further alternative embodiment, the valve-side end region 36 continues in the axial direction A into an axial section that is adjacent to the valve-side axial end 30 and can be designed as desired.

The adapter sleeve 22 has a plurality of radial depressions 44 on its outer circumference 42, which in the present case are each formed by a surrounding circumferential groove 46 in the circumferential direction U.

Basically, the outer circumference 42 of the adapter sleeve 22 may be of any desired shape, for example with one or more radial depressions 44 of any desired shape.

Furthermore, on its outer circumference 42, the adapter sleeve 22 has a radial projection 48, which here protrudes in a block shape beyond the outer circumference 42 in the radial direction.

In an alternative embodiment, the adapter sleeve 22 may, of course, have any desired number of radial projections 48 on its outer circumference 42, each of which is designed as desired.

Apart from the internal thread 34 and the radial projection 48, in the illustrated exemplary embodiment the adapter sleeve 22 is designed to be rotationally symmetrical with respect to its longitudinal axis L.

The clamping sleeve 24 (see FIG. 4) has a passage opening 50 that extends in the axial direction A from a pipe-side axial end 52 to an opposite, valve-side axial end 54.

Furthermore, the clamping sleeve 24 has a plurality of elastic segments 56 which are spaced apart from each other in the circumferential direction U by axial slits 58.

The axial slits 58 here extend from the valve-side axial end 54 counter to the axial direction A toward the pipe-side axial end 52.

At the pipe-side axial end 52, the clamping sleeve 24 has a flange 60 surrounding it in the circumferential direction U, which protrudes radially in relation to an outer circumferential surface 62.

At the valve-side axial end 54, the clamping sleeve 24 has a collar 64 which protrudes radially in relation to the circumferential surface 62 and surrounds it in the circumferential direction U and is interrupted by the axial slits 58. In other words, the segments 56 each include a section of the collar 64 radially on the outside at their valve-side axial end 54.

On the inside 66 of the clamping sleeve 24 adjacent to the passage opening 50, the segments 56 further each have a barb extension 68 which extends into the passage opening 50 in the axial direction A and also radially inward and thus obliquely from the inside 66 toward the valve-side axial end 54.

Apart from the axial slits 58 and the barb extensions 68, in the exemplary embodiment shown, the clamping sleeve 24 is designed to be rotationally symmetrical with respect to its longitudinal axis L.

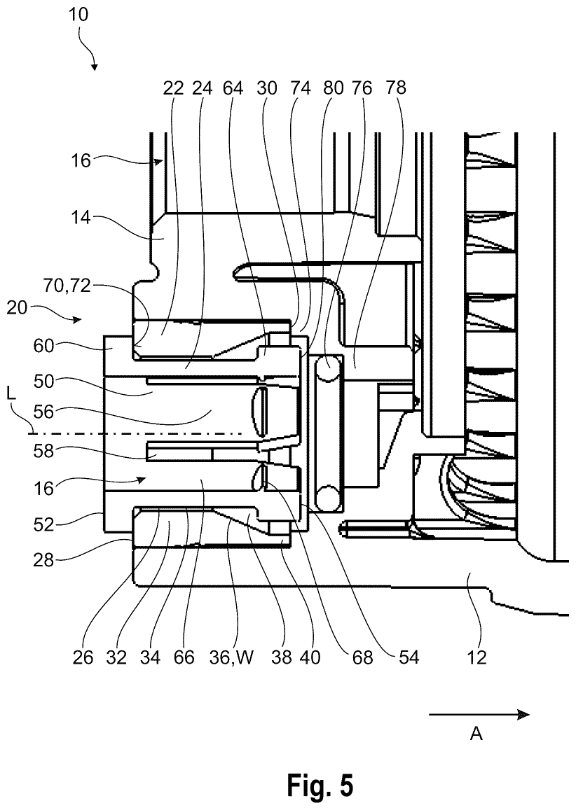

In all embodiments, the clamping sleeve 24 is configured and dimensioned such that the clamping sleeve 24 can be inserted into the passage opening 26 of the adapter sleeve 22 in the axial direction A with the valve-side axial end 54 first (see FIG. 5). In this context, the adapter sleeve 22 is configured and dimensioned such that the segments 56 in the pipe-side end region 32 are first elastically deflected radially inwards here and subsequently spring radially outwards in the valve-side end region 36, where they engage in the widening 38 by the collar 64.

The clamping sleeve 24 is thus captively held in the adapter sleeve 22.

When connected to each other, the adapter sleeve 22 and the clamping sleeve 24 are, for example, aligned coaxially with each other, i.e., the longitudinal axis L of the adapter sleeve 22 and the longitudinal axis L of the clamping sleeve 24 are identical.

In the interconnected state, the flange 60 (see FIG. 5) protrudes beyond the passage opening 26 of the adapter sleeve 22 in the radial direction and has a face side 70 which faces the adapter sleeve 22 and forms an axial stop 72 for the pipe-side axial end 28 of the adapter sleeve 22.

To disconnect the clamping sleeve 24 from the adapter sleeve 22 again, the clamping sleeve 24 can be pulled out of the passage opening 26 of the adapter sleeve 22 counter to the axial direction A. In the process, the segments 56 are elastically deflected radially inward by a wall W defining the widening 38, so that the collar 64 fits through the passage opening 26 of the adapter sleeve 22.

Furthermore, the adapter sleeve 22 is made of metal, which makes the internal thread 34 particularly robust.

Alternatively, the adapter sleeve 22 may be made from a plastic material.

The clamping sleeve 24 is made from a plastic material or a metal, for example.

The valve housing 12 is an injection molded part, for example made from a plastic material.

In the present exemplary embodiment, in manufacturing the valve unit 10, the adapter sleeve 22 was overmolded in the connection port 16 and is therefore connected with the housing wall 14 with an interlocking fit and an inter-material bond (see FIG. 5).

In this context, the radial depressions 44 constitute an axial anti-pull-out means which ensures that the adapter sleeve 22 cannot be pulled out of the connection port 16 counter to the axial direction A.

Furthermore, the radial projection 48 constitutes an anti-rotation locking contour K (see FIG. 3), which prevents the adapter sleeve 22 from being rotated relative to the housing wall 14 in the circumferential direction U.

The adapter sleeve 22 is thus rigidly attached to the housing wall 14.

Alternatively, the adapter sleeve 22 may be pressed and/or glued into the connection port 16.

Adjacent to the connection port 16, the housing wall 14 has a stop 74 (see FIG. 5) in the form of a shoulder against which the adapter sleeve 22 rests on its face side by the valve-side axial end 30 in the axial direction A.

Furthermore, the valve unit 10 includes a sealing ring 76 which is adjacent to a shoulder 78 of the housing wall 14 in the axial direction A, the shoulder 78 delimiting the connection port 16.

The sealing ring 76 here is arranged axially opposite to a face side 80 at the valve-side axial end 54 of the clamping sleeve 24 and thus in the axial direction A between the face side 80 of the clamping sleeve 24 and the shoulder 78 of the housing wall 14.

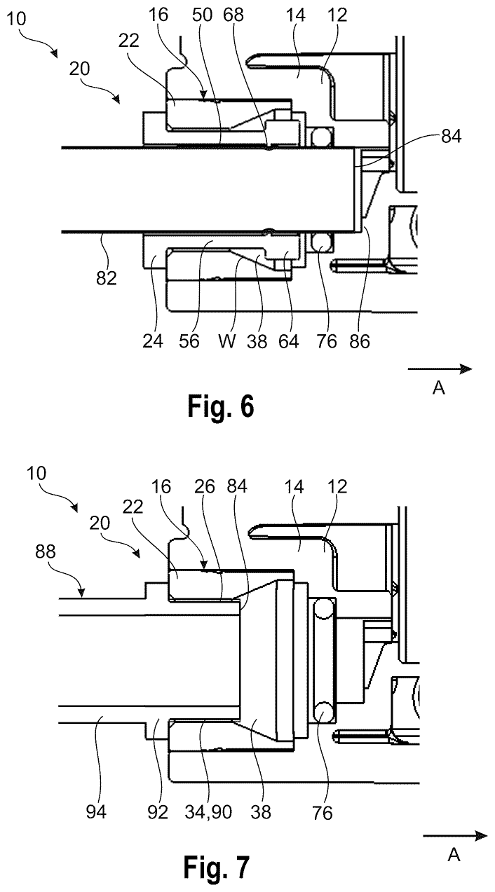

FIG. 6 shows how a fluidic connecting pipe 82 is connected to the connection port 16 by means of the adapter sleeve 22 and the clamping sleeve 24.

In order to connect the connecting pipe 82 to the connection port 16, the connecting pipe 82 is inserted by a connecting end 84 into the passage opening 50 of the clamping sleeve 24 in the axial direction A until the connecting pipe 82 extends through the sealing ring 76.

The sealing ring 76 here rests tightly against the outer circumference of the connecting pipe 82.

In the present exemplary embodiment, the valve housing 12 has a further shoulder 86, which constitutes an axial stop for the connecting end 84 and in this way reliably ensures that the connecting pipe 82 is arranged sufficiently far or in a defined manner in the connection port 16.

In this context, the connecting pipe 82 has a diameter that substantially corresponds to the diameter of the passage opening 50 of the clamping sleeve 24. As a result, the barb extensions 68 rest directly radially against the outside of the connecting pipe 82.

When the connecting pipe 82 is pulled out of the connection port 16 counter to the axial direction A, the barb extensions 68 cause the clamping sleeve 24 to be displaced together with the connecting pipe 82 in relation to the adapter sleeve 22 counter to the axial direction A.

In the process, the collar 64 is pressed against the wall W of the widening 38, as a result of which the segments 56 are increasingly pressed inward in the radial direction and correspondingly clamp the connecting pipe 82 increasingly tightly.

The clamping force applied to the connecting pipe 82 in this process may be so great that the connecting pipe 82 cannot be manually pulled off unintentionally and is thus secured axially.

In order to intentionally disconnect the connecting pipe 82 from the valve connection adapter 20, it is necessary to secure the clamping sleeve 24 axially in relation to the adapter sleeve 22, for example using one hand, while the other hand pulls the connecting pipe 82 out of the passage opening 50 of the clamping sleeve 24 counter to the axial direction A.

In this way, the segments 56 are not pressed together and therefore the connecting pipe 82 is not radially clamped by the clamping sleeve 24.

As an alternative, as is illustrated in FIG. 7, a fluidic connecting pipe 88 having an external thread 90 configured to be complementary to the internal thread 34 of the adapter sleeve 22 can be connected to the connection port 16 by means of the adapter sleeve 22.

The external thread 90 here is part of a pipe connection 92 which is connected to a pipe section 94 of the connecting pipe 88 and constitutes the connecting end 84 of the connecting pipe 88.

In an alternative embodiment, the external thread 90 is formed directly in the outer jacket surface of the connecting pipe 88 or the pipe section 94.

To connect the connecting pipe 88 to the connection port 16, first the clamping sleeve 24 is removed from the adapter sleeve 22 or the adapter sleeve 22 is used without the clamping sleeve 24.

The connecting pipe 88 is now screwed by the external thread 90 to the internal thread 34 of the adapter sleeve 22 and is thereby reliably and tightly connected to the valve housing 12.

The pipe connection 92 here may be rotatable in the circumferential direction U relative to the pipe section 94, so that the connecting end 84 can be screwed to the adapter sleeve 22 without the pipe section 94 also having to be rotated.

In this way, a valve connection adapter 20 and a valve unit 10 having a valve connection adapter 20 are provided, by means of which both connecting pipes 82 without external threads 90 and connecting pipes 88 with external threads 90 can be effectively and reliably connected to the connection port 16 in terms of flow, as required.

Therefore, any connection port 16 formed with a valve connection adapter 20 can be flexibly used for both types of connecting pipes 82, 88.

1. A valve connection adapter for connecting a fluidic connecting pipe to a valve, comprising an adapter sleeve which has a valve-side axial end and an opposite, pipe-side axial end and an axial passage opening, wherein the passage opening has an internal thread at a pipe-side end region and a widening at the valve-side end region.

2. The valve connection adapter according to claim 1, wherein the widening is conical.

3. The valve connection adapter according to claim 1, wherein the valve-side end region continues into a cylindrical section toward the valve-side end.

4. The valve connection adapter according to claim 1, wherein the adapter sleeve has at least one of depressions and projections on its outer circumference.

5. The valve connection adapter according to claim 1, wherein the adapter sleeve has at least one of circumferential grooves and an anti-rotation locking contour (K) on the outer circumference.

6. The valve connection adapter according to claim 1, wherein the valve connection adapter includes a clamping sleeve which is provided with axial slits and has a valve-side axial end and an opposite, pipe-side axial end and has, at its valve-side end, a collar projecting radially outward in segments defined by the slits, wherein the segments and the collar are adapted in cross-section to the geometry of the passage opening such that the clamping sleeve can be axially inserted into the passage opening with the segments deflecting inward, and the collar engages in the widening.

7. The valve connection adapter according to claim 6, wherein the clamping sleeve has a circumferentially surrounding flange at its pipe-side end, which protrudes radially in relation to the adapter sleeve and forms an axial stop.

8. A valve unit comprising a valve connection adapter for connecting a fluidic connecting pipe to a valve, the valve connection adapter having an adapter sleeve which has a valve-side axial end and an opposite, pipe-side axial end and an axial passage opening, wherein the passage opening has an internal thread at a pipe-side end region and a widening at the valve-side end region, the valve unit further comprising a valve housing having a connection port which is formed in the housing wall of the valve housing and in which the adapter sleeve is inserted and secured therein against rotation and axial withdrawal.

9. The valve unit according to claim 8, wherein the adapter sleeve is pressed or glued into the connection port or overmolded therein.

10. The valve unit according to claim 8, wherein a connecting pipe is screwed into the thread of the adapter sleeve.

11. The valve unit according to claim 8, wherein the valve connection adapter includes a clamping sleeve which is provided with axial slits and has a valve-side axial end and an opposite, pipe-side axial end and has, at its valve-side end, a collar projecting radially outward in segments defined by the slits, wherein the segments and the collar are adapted in cross-section to the geometry of the passage opening such that the clamping sleeve can be axially inserted into the passage opening with the segments deflecting inward, and the collar engages in the widening, and wherein a connecting pipe protrudes into the clamping sleeve and is radially clamped therein.

12. The valve unit according to claim 11, wherein the collar presses against the wall (W) of the widening.

13. The valve unit according to claim 11, wherein that the clamping sleeve has barb extensions on its inside which protrude obliquely inward and toward the valve and which axially secure the connecting pipe received.

14. The valve unit according to claim 8, wherein the valve connection adapter includes a clamping sleeve which is provided with axial slits and has a valve-side axial end and an opposite, pipe-side axial end and has, at its valve-side end, a collar projecting radially outward in segments defined by the slits, wherein the segments and the collar are adapted in cross-section to the geometry of the passage opening such that the clamping sleeve can be axially inserted into the passage opening with the segments deflecting inward, and the collar engages in the widening, and wherein a sealing ring is seated on a shoulder in the connection port axially between the shoulder and a face side of the clamping sleeve.

15. The valve unit according to claim 8, wherein the connection port has a stop on which the adapter sleeve rests on its face side.
